(19) United States
(12) Patent Application Publication
(10) Pub. No.: US 2008/0211336 A1
(43) Pub. Date: Sep. 4, 2008

(54) Rotating Transverse Flux Machine

(75) Inventor: Chandur Sadarangani, Vasteras (SE)

Correspondence Address: VENABLE LLP, P.O. BOX 34385, WASHINGTON, DC, 20043-9998, US

(73) Assignee: ABB Research Ltd., Zurich (CH)

(21) Appl. No.: 11/667,553

(22) PCT Filed: Nov. 11, 2004
(86) PCT No.: PCT/SE04/01649

§ 371 Date: Nov. 19, 2007

(51) Int. Cl. H02K 21/12; F03D 9/00; H02K 15/00

(52) U.S. Cl. 310/156.02; 29/596; 290/55

(57) ABSTRACT

A transverse flux rotating machine including a first interacting part including an electric winding and a second interacting part including a plurality of magnetic poles. The first and second interacting parts are movable relative to each other and defining between them an airgap.

### TECHNICAL FIELD

The present invention concerns a transverse flux machine. More precisely the invention concerns a machine and a method for accomplishing a rotating movement with a transverse flux operation. Especially the invention concerns a transverse flux machine comprising a first and second interacting part, which are movable relatively to each other. The first part comprises an electric winding and the second part comprises a plurality of magnet poles. The first part is often known as a stator and the second part is known as a rotor. In the following text such a machine is denoted a transverse flux rotating machine.

### BACKGROUND OF THE INVENTION

In a conventional electric machine the plane of the magnetic flux is aligned with the plane of movement while the plane of current is perpendicular to both of these planes. In a transverse flux machine the plane of current is aligned with the plane of movement while the plane of the magnetic flux is perpendicular to both of these planes. Most transverse flux machines use permanent magnets on a movable part and windings on a stationary part. Widely known is also the use of magnetizable cores to concentrate the magnetic flux.

Transverse flux machines are favorable for achieving a high torque density between the stationary part and the movable part. However, transverse flux machines are generally considered as difficult to manufacture and because of their complicated structure too expensive.

A wide variety of different constructions are known in the prior art. Generally a plurality of permanent magnets is assembled in a line to form the movable part. In rotating machines this line is in the form of a cylindrical body. Often these permanent magnets must be glued to the movable part. The electromagnetic circuit is then formed from a winding and a core. The core is made of a magnetizable material such as soft iron or a soft magnetic composite. In many known embodiments of TFPM machines these cores have to be constructed of a plurality of parts.

Among known embodiments of transverse flux machines there are at least four distinctive types. There is the double-sided, double-winding TFPM machine which has a first winding and a first U-shaped core on one side of the movable part, and a second winding and a second U-shaped core on the opposite side of the movable part. There is the double sided, single-wound TFPM machine which is the same as the previous machine but with only one winding and a U-formed core on both sides of the movable part. These designs are known as U-Core arrangement where the movable part is sandwiched between the two U-formed cores. Both of these machines involve a plurality of core parts that must be aligned and built around the movable part. This design leads to thicker air gaps due to deformations in the construction of the movable part.

From U.S. Pat. No. 5,973,436 (Mitcham) an electric machine is previously known. The object of this transverse flux machine is to reduce the amount of electromagnetic couplings. This machine represents the double-sided, single-wound machine with a C-core arrangement. Thus this machine has a core arrangement which is clamped around the edge of the movable part. In this design the number of magnets is halved but also half the air gaps are removed. Expectedly the torque density of this design is roughly half the torque density of the U-Core version.

From U.S. Pat. No. 5,633,551 (Weh) a machine with transverse flux is previously known. The object of the machine is to improve the effectiveness of the exciter members and to simplify manufacture. This machine is known as the E-Core configuration. Thus, the core has two windings and an E-shaped core. The movable part comprises two lines of assembled permanent magnets. In the embodiment disclosed, the movable part comprises two concentric cylindrical shells. In production, however, there will be difficulty in forming and assembling an E-shaped core between the two windings. Also this machine has four air gaps and the risk of even thicker air gaps is obvious. A variety of the E-core construction is previously known from U.S. Pat. No. 6,717,297 (Sadarangani).

Finally there is the single sided, single-wound machine. In a first embodiment this machine is a clawpole transverse flux machine. The movable part comprises a single row of magnetic poles. In a first embodiment each pole comprises an open permanent magnet with its flux orientation perpendicular to the movement. Every second magnet is oriented in antiparallel with the adjacent magnets. In a second embodiment each pole comprises a flux concentrator in the form of a soft iron piece and a permanent magnet on each side. This is known as the buried magnets arrangement. Each of the two magnets has a flux orientation in parallel with the movement but in antiparallel with each other. Thus the flux of the two magnets is concentrated in the soft iron piece between the two magnets and directed perpendicular to the movement of the movable part. Every soft iron piece thus forms a pole with the magnetic flux interacting with the magnetic flux of the stationary part. The stationary part in this machine comprises a plurality of claw-shaped cores and a winding aligned in the direction of the movement of the movable part. Each core is wound around the winding and comprises a first and second outer tip in an overlap joint, such that the first tip is oriented in parallel with the second tip but separated by one pole distance in the direction of the movement.

In a second embodiment of the single, single-wound machine the movable part comprises first and second parallel rows of poles. Each pole may comprise a permanent magnet or an arrangement with a flux concentrator and two buried permanent magnets as described above. Each row comprises a plurality of poles every second of which with its magnetic flux oriented perpendicular to the movement but antiparallel to each other. The first row of poles is displaced one pole distance in the direction of the movement such that in a cross section perpendicular to the movement a pole in the first row has an opposite flux direction to a pole in the second row. The stationary part comprises in this embodiment a plurality of U-shaped core pieces and a winding aligned along the movement of the movable part.

Energized by the winding a first U-formed core piece forms an upper magnetic flux loop transverse to the movement. A lower flux loop is formed by a first and a second pole and a second U-formed core piece. In a first embodiment the first core piece is located in the stationary part and the second core piece located in the movable part. The magnetic flux loop thus comprises the first U-shaped core piece, a first pole in the first row of poles, the second U-shaped core piece, and a second pole in the second row of poles.

In a second embodiment the lower flux loop is shaped by a pair of adjacent poles in each row of poles and a second U-formed core piece placed in the stationary part. The first U-formed core piece is wound around the winding while the second core piece is not. The second core pieces are placed between the first core pieces and each second core piece passes under the winding from the first row of poles to the second row of poles. The magnetic flux loop thus comprises the first U-shaped core piece, a first pole in the first row of poles, an adjacent pole in the first row of poles, the second core piece, a second pole in the second row of poles and an adjacent pole in the second row of poles.

The single sided, single-wound transverse flux machine allows laminated steel to be used in the stationary part. The specific iron losses are then about seven times lower than nonlaminated steel. Thus a machine having a laminated core is far more efficient than a non-laminated core. One significant problem in single sided TFPM machines is the magnetic flux leakage between the stationary core and the core forming the return path of the magnetic flux. This leakage may however be reduced partly by the design of the cores and partly by making the permanent magnets and their concentrators longer than the fastening assembly. Although possible the cores cannot be placed too narrow in the direction of the movement because of flux leakage between the core pieces.

Even though the known transverse flux machines may be designed to be more efficient they still exhibit a plurality of parts that must be assembled in a manner demanding a great deal of manual work. Thus there is a need for a production friendly but still efficient transverse flux rotating machine.

### SUMMARY OF THE INVENTION

A primary object of the present invention is to provide a transverse flux rotating machine that offers a high torque density and at the same time provides a simple design. Yet another object is to provide a transverse flux rotating machine comprising a standard lamination structure. Still a further object is to provide a rotating transverse flux machine suitable for low speed applications.

This object is achieved according to the invention by a transverse flux rotating machine characterized by the features of the independent claim 1 or by a method characterized by the steps of the independent claim 12. Preferred embodiments are described in the dependent claims.

In a first aspect of the invention the transverse flux rotating machine comprises a first interacting part comprising an electric winding and a second interacting part containing a plurality of magnetic poles. The two interacting parts are movable relative to each other and define between them an airgap. Further, when energized by the winding, the machine comprises a plurality of magnetic flux loops oriented in a plane in parallel with the axis of rotation. A bundle of the magnetic flux loops forms a leg portion crossing the airgap. The leg portion comprises a first leg part located in the first interacting part and a second leg part located in the second interacting part. The first leg part comprises an elongated magnetic flux conductor. The second leg part comprises a magnetic pole. The elongated magnetic flux conductor is surrounded by an electric coil for creating within the leg portion a magnetic flux interacting with the magnetic flux of the pole. The coil constitutes a part of the electric winding. The electric winding according to the invention is thus wound around the magnetic flux conductor instead of the magnetic flux conductor being wound around the winding as in prior art transverse flux machines.

The first interacting part of the transversal flux machine comprises a stator back and the second interacting part comprises a rotor back. The stator back and the rotor back are made of a magnetic flux conducting material. The stator back is magnetically connecting a plurality of elongated magnetic flux conductors in a plane parallel with the axis of rotation. The rotor back is connecting a plurality of magnetic poles in a plane parallel with the axis of rotation. Thus, the magnetic flux in the stator back and in the rotor back complete the magnetic flux loops in the machine.

In preferred embodiments of the invention the pole comprises an open permanent magnet or a buried permanent magnet arrangement. In a further embodiment the poles comprises electromagnets which are fed by a slip ring arrangement. In yet another embodiment of the invention the magnetic flux conductor comprises a tooth-shaped core of a magnetizable material. In yet another embodiment the core comprises a plurality of teeth combined with a flux conducting stator back arranged in a line along the airgap and in a plane parallel to the axis of rotation. In yet another embodiment of the invention the poles of the first interacting part are arranged in circular rows, each of which oriented in a plane perpendicular to the axis of rotation. Still in a further embodiment the poles of adjacent circular rows are displaced in the tangential direction such that the transverse flux rotating machine is operable by a plurality of phases.

In a preferred embodiment the second interacting part comprises a wheel-formed rotor with a peripheral tubular cross section and the first interacting part comprises a stator surrounding the rotor. The airgap in this embodiment thus has a form as a part of a circular tube. A plurality of poles including permanent magnets are arranged in circular rows oriented in planes perpendicular to the axis of rotation. A plurality of magnetizable teeth surrounded by coils is arranged in lines along the airgap, each line being oriented in a plane in parallel with the axis of rotation. In a further embodiment the airgap forms a part of a circle in a cross section of the machine. Every second pole in a row has a magnetic flux orientation opposite to the flux orientation of an adjacent pole in the row. Each pole in a row is separated from the next pole by a distance equal to the distance between two adjacent teeth in the direction of the movement. In a preferred development of this embodiment the row of poles comprises two poles within a distance between a first edge of a first tooth and the first edge of a following tooth in the direction of the movement. In this embodiment the winding comprises electric coils that are wound around a plurality of teeth in the direction of the movement.

In yet a preferred embodiment of the invention the transverse flux machine comprises a multiphase machine. In this embodiment the poles of different rows are displaced evenly in the direction of the movement according to the number of phases. Thus for a three phase machine a pole of a row representing the second phase is displaced two third of the distance between two poles of the first row. Consequently a pole in a row representing the third phase is displaced four thirds of the distance between two poles of the first row. Different phases may be arranged in adjacent rows or may be distributed and mixed with the other phases. Thus for the three phase machine the displacement to accommodate between the phases represents 120 electrical degrees.

In yet a further embodiment of the invention the poles of the second interacting part comprises a Halbach arrangement of permanent magnets. A Halbach arrangement is characterized by providing a plurality of permanent magnets in a row where the flux orientation of two adjacent magnets is perpendicular or less. Thus in a first Halbach arrangement the flux orientation of five adjacent magnets in a row is 0, 45, 90, 135 and 180 degrees. In a second Halbach arrangement called a Quasi Halbach arrangement the flux orientation of three adjacent magnets are 0, 90 and 180 degrees. In a further embodiment the permanent magnets are provided with a rotor back of a thin core piece of a magnetizable material. The embodiment of combining a Halbach arrangement with a magnetic flux conductor may be called a Hybrid Halbach arrangement.

In a second aspect of the invention the objects are achieved by a method for forming a magnetic flux between a first and second relatively rotatable interacting parts of a transverse flux machine separated by an airgap. The method comprises providing a plurality of transverse magnetic flux loops oriented in a plane in parallel with the axis of rotation. Assembling a bundle of the magnetic flux loops to form a leg portion crossing the airgap, the leg portion having a first part located in the first interacting part and a second part located in the second interacting part. Further the method provides for the first leg part to comprise an elongated magnetic flux conductor and for the second leg part to comprise a magnetic pole. The method further provides a winding comprising an electric coil to be wound around the flux conductor for generating within the leg portion a magnetic flux interacting with the magnetic flux of the pole.

In a further embodiment of the method the elongated magnetic flux conductors are arranged as teeth with a magnetic flux conducting stator back and arranged in a line along the airgap the lines being oriented in a plane parallel to the axis of rotation. In yet a further embodiment the poles of the second interacting part are arranged in circular rows, each oriented in a plane perpendicular to the axis of rotation.

### BRIEF DESCRIPTION OF THE DRAWINGS

Other features and advantages of the present invention will become more apparent to a person skilled in the art from the following detailed description in conjunction with the appended drawings in which:

FIG. 1 is a principle sketch of the difference between a regular electric machine and a transverse flux machine,

FIG. 2 is a transverse flux machine according to the prior art,

FIG. 3 is a transverse flux machine according to the invention,

FIG. 4 is a second embodiment of a transverse flux machine according to the invention,

FIG. 5 is a third embodiment of a transverse flux machine according to the invention,

FIG. 6 is a cross section of a further embodiment of a transverse flux machine according to the invention,

FIG. 7 is a magnetic flux loop through the airgap of a transverse flux machine according to the invention,

FIG. 8 is a cross section of a three phase transverse flux machine according to the invention,

FIG. 9 is a longitudinal section of a transverse flux machine according to the invention,

FIG. 10 is a three dimensional view of a rotor according to the invention,

FIG. 11 is s first embodiment of a multiphase transverse flux machine, and

FIG. 12 is a second embodiment of a multiphase transverse flux machine.

### DESCRIPTION OF PREFERRED EMBODIMENTS

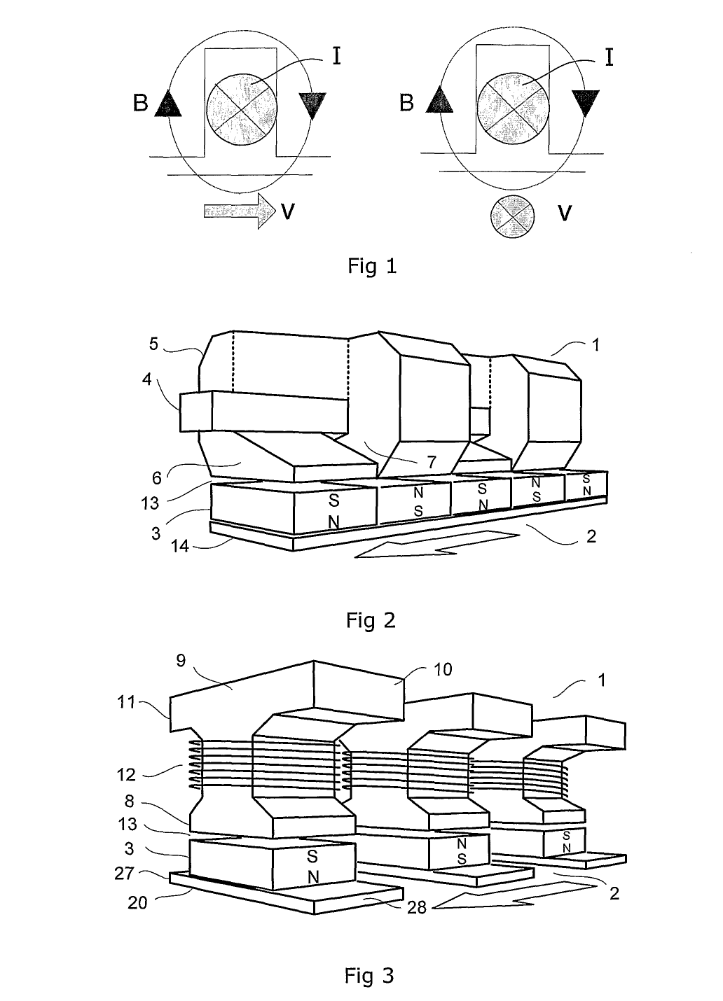

In a conventional electric machine the plane of the magnetic flux B is aligned with the plane of movement V while the plane of current I is perpendicular to both of these planes. This is shown in the left part of FIG. 1. In a transverse flux machine the plane of current I is aligned with the plane of movement V while the plane of the magnetic flux B is perpendicular to both of these planes. This is shown in the right part of FIG. 1.

A transverse flux machine according to the prior art is shown in FIG. 2. The machine comprises a stator part 1 and a rotor part 2 movable in the direction of the arrow in the lower part of FIG. 2. The rotor part comprises a plurality of permanent magnets 3 arranged in a row on a magnetic flux conducting rotor back 14. The magnetic flux orientation of adjacent magnets is in antiparallel with each other. The stator comprises a winding 4 and a plurality of core pieces 5. The winding comprises a plurality of strands in a bundle aligned in the direction of the movement. The core pieces are formed of magnetizable sheet material. Each core piece comprises a claw-formed body 5 with a first tip 6 and a second tip 7 (mostly hidden). When energized by the winding the first and second tips of the same core piece are interacting with first and second adjacent magnets in the row. When energized by the winding a plurality of magnetic flux loops are formed, each of which comprising the claw-shaped core piece, a first magnet of a row, the rotor back, and a second magnet in the same row. The magnetic flux loop thus formed has one part transverse to the direction of movement and a second part along the direction of movement.

A transverse flux linear machine with permanent magnets according to invention is shown in FIG. 3. The machine comprises a stator part 1 and a rotor part 2 movable in the direction of the arrow shown in the lower part of FIG. 3. The stator part and the rotor part are separated from each other by an airgap 13. The stator part comprises a plurality of teeth 8 arranged in a line in the direction of the movement. Each tooth is supported by a stator back 9 of a magnetically conducting material. An electric coil 12 for generating a magnetic flux in a direction perpendicular to the movement is wound around each tooth. The stator part in the figure is restricted to one line of teeth only. Thus the stator back 9 in the figure shows a first 10 and second 11 cut surface for indicating the integration of a plurality of teeth with a common stator back along the airgap and perpendicular to the movement. The direction of the magnetic flux of adjacent teeth in the line of movement is in antiparallel with each other when energized by the coils of winding.

The rotor part comprises a plurality of poles 3 arranged in a row in the direction of the movement. Each pole comprises in the embodiment shown a permanent magnet. The magnetic flux orientation of adjacent magnets is in antiparallel with each other. Each magnet is supported by a rotor back 20 of a magnetically conducting material. Like the stator back above the rotor back in the figure shows a first cut surface 27 and a second cut surface 28 for indicating the integration of a plurality of rotor backs into a common rotor back along the airgap and perpendicular to the movement.

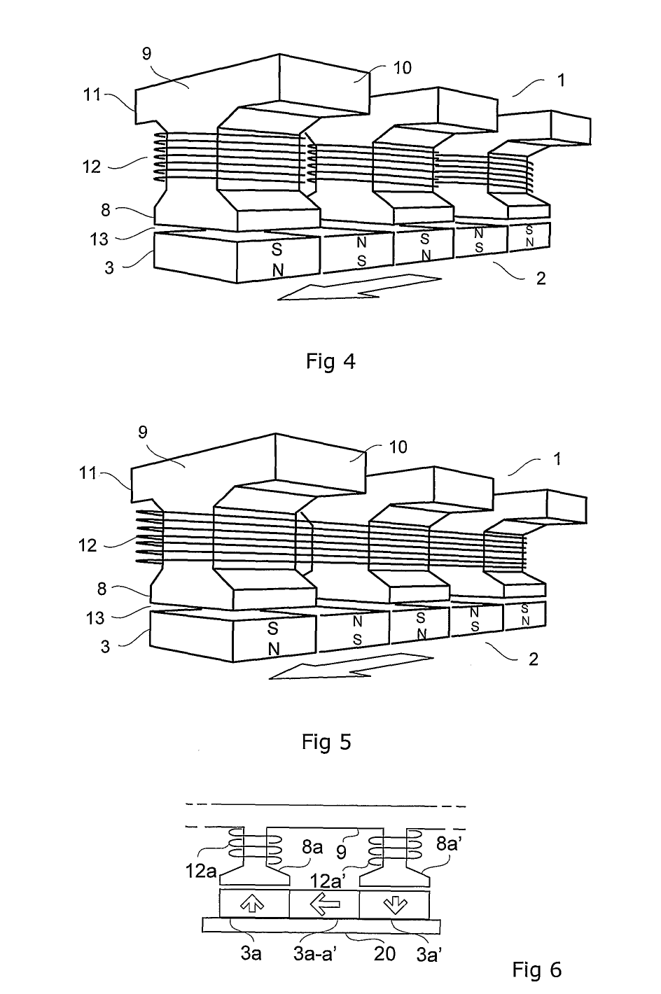

A second embodiment of the transverse flux machine according to the invention is shown in FIG. 4. The machine comprises a stator 1 and a rotor 2 separated by an airgap 13. The stator comprises a plurality of teeth 8, each surrounded by an electric coil 12. This is known as a local coil arrangement. In this embodiment all teeth along the row of poles have the same magnetic flux direction when energized by the winding. The flux direction changes by the direction of the current in the electric coils. In this embodiment there are twice as many poles as teeth in the direction of the movement. Every second pole in the row thus has a flux direction in parallel with each other but in antiparallel with the poles in between.

A further development of the transverse flux machine according to the invention is shown in FIG. 5. The machine comprises a stator 1 and a rotor 2 separated by an airgap 13. The stator comprises a plurality of teeth 8 arranged along the airgap. In fact this embodiment comprises the same teeth and poles arrangement as in the previous figure but the winding is different. According to the embodiment in FIG. 5 each coil surrounds a plurality of teeth. This is called a global winding and consequently all teeth within the coils have the same magnetic flux direction.

A cross section of a transverse flux machine is shown in FIG. 6. Thus the direction of movement is in and out of the paper plane. In the embodiment shown the magnets 3 of the rotor are positioned in a Halbach arrangement. In order to conduct the magnetic flux within a thin layer in the rotor two opposite poles in adjacent rows are combined with a common magnetic element. Thus a first magnet 3a of a first row of magnets and a second magnet 3a′ of the second row of magnets are combined with a third permanent magnet 3a-a′ in between. When energized by a winding comprising a first coil 12a and a second coil 12a′ a magnetic flux loop is formed in a clockwise direction by the first magnet 3a, a first tooth 8a, the stator back 9, a second tooth 8a′, the second magnet 3a′ and the third magnet 3a-a′. In the embodiment shown a magnetic flux conductor 20 in the form of a piece of soft iron is placed behind the magnets. The magnet arrangement in the figure is called a Quasi Halbach arrangement. A Halbach arrangement may also comprise a plurality of magnets between the two pole magnets. Thus in a second Halbach arrangement the flux orientation of five adjacent magnets in a line is 0, 45, 90, 135 and 180 degrees.

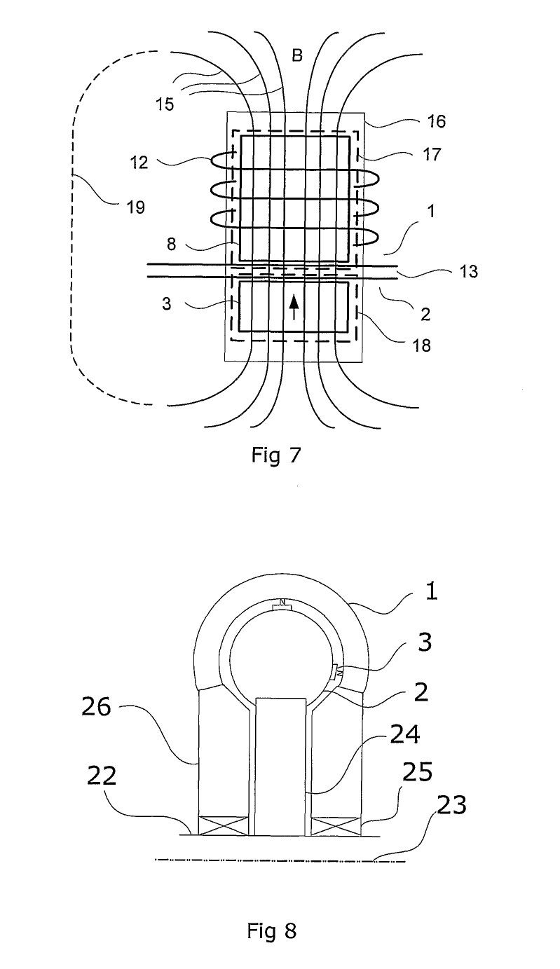

The essence of the present invention is shown in FIG. 7. The transverse flux machine comprises a first interacting part 1 and the second interacting part 2 separated by an airgap 13. Further the machine comprises at least one magnetic flux loop 15 oriented in a plane perpendicular to the movement. Only a part of the loops are shown in the figure. A bundle of magnetic flux loops forms a leg portion 16 crossing the airgap 13. The leg portion comprises a first leg part 17 located in the first interacting part and a second leg part 18 located in the second interacting part. The first leg part 17 comprises a tooth part 8 of the core and the second leg part 18 comprises a magnetic pole 3 which in the embodiment shown is a permanent magnet. In an equivalent embodiment the pole comprises an electromagnet. The first interacting part comprises an electric coil 12 wound around each tooth 8.

Although not shown in FIG. 7 the first interacting part comprises a stator back and the second interacting part comprises a rotor back for conducting the magnetic flux transverse to the direction of movement. Accordingly the loops are completed by a second leg 19 or a plurality of branched legs passing the airgap in the same plane perpendicular to the movement.

In FIG. 8 a section of a rotating transverse flux machine according to the invention is shown. The machine comprises a stator 1 and a rotor 2. The rotor comprises a shaft 22 rotatable arranged around an axis 23. The rotor further comprises a spoke wheel 24 the peripheral part of which containing a tubular section on which a plurality of permanent magnets 3 are attached in rows. The stator comprises a housing 26 containing bearings 25 in which the shaft 22 is journalled. The stator further contains a plurality of teeth (not shown) around which are wound electrical coils being parts of the winding.

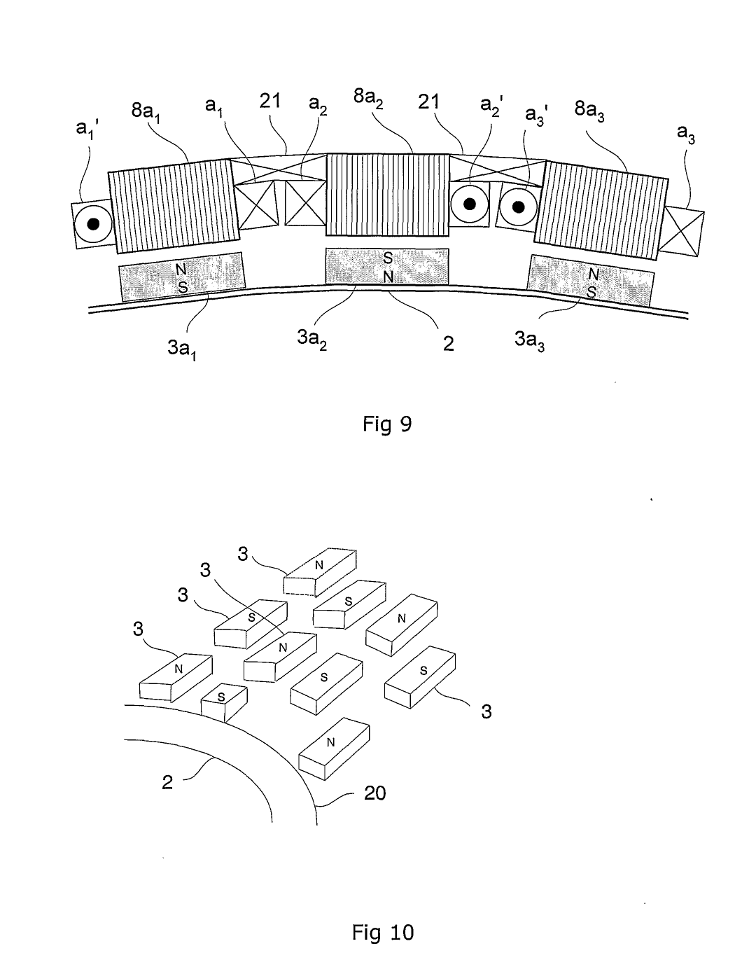

A close up section stator and rotor of the transverse flux machine above is shown in FIG. 9. In the embodiment shown there is a first tooth 8a₁ interacting with a first magnet 3a₁, a second tooth 8a₂ interacting with a second magnet 3a₂ and a third tooth 8a₃ interacting with a third magnet 3a₃. Around each tooth there is a winding in the form of a coil a₁, a₂, a₃ wound around each tooth. Each magnet is attached to the rotor 2 of the machine. In order to form separate magnetic loops in the transverse direction the teeth have to be separated from each other in the direction of movement. The lines of integrated teeth are separated by a member 21 that is not magnetically flux conducting. Thus a space is formed between the lines of teeth. This has to be done also in the machines of the prior art. In a prior art machine however this space cannot fulfill any function and consequently it affects the efficiency of the machine. In the machine according to the invention the space formed between the two lines of teeth is used for winding location.

Normally in the prior art the core pieces of each phase must be displaced in the direction of the movement. According to the invention the magnets are displaced instead. An outer surface of a rotor according to the invention is shown in FIG. 10. The rotor 2 comprises a back 20 on which a plurality of permanent magnets 3 is attached. One way of attaching the magnets is gluing. As can be seen from the figure the magnets are organized in rows but with the magnets displaced in the direction of movement.

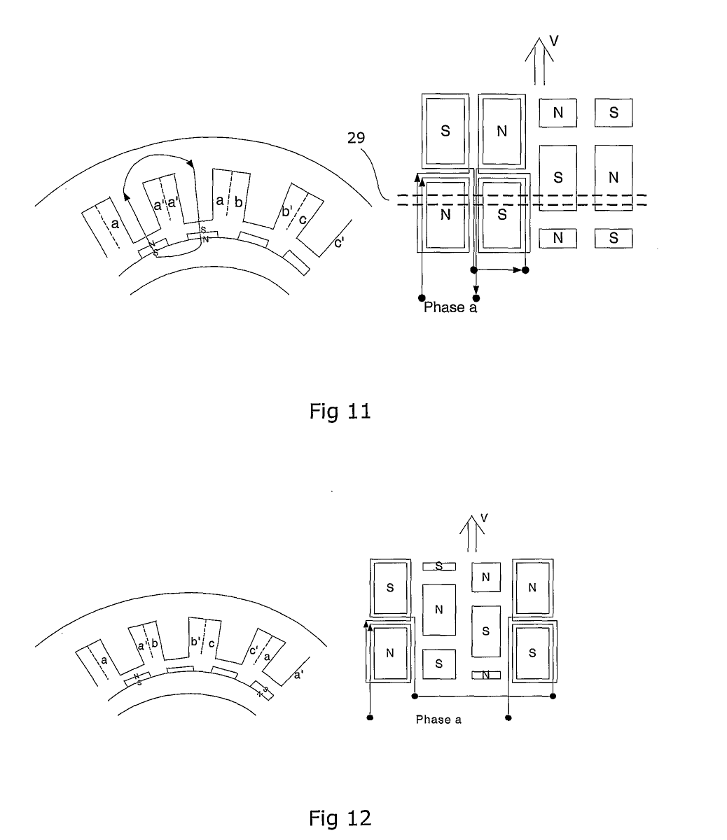

A first arrangement of a transverse flux machine with a plurality of phases is shown in FIG. 11. On the left side of the figure there is shown a section through the machine with a magnetic flux loop formed by the permanent magnets. On the right side is shown the arrangement of permanent magnets on the rotor surface. It is thus evident that the phase windings of the machine may be mixed in a plurality of ways. The only restriction is that within a cross section of the geometry the sum of flux entering the stator from the rotor through the airgap must be equal to the sum of flux leaving the stator to the rotor through the airgap. Thus in a narrow slot window 29 oriented in the plane of the airgap must when passing over the magnets in the direction of the movement show an equal sum of magnet surfaces having its flux direction upwards from the paper and downwards into the paper respectively.

A second arrangement of a transverse flux machine with a plurality of phases is shown in FIG. 12. On the left side of the figure there is shown a section through the machine and on the right side is shown the arrangement of permanent magnets on the rotor surface. Also in this embodiment it is important that an equal sum of magnet surfaces of the right hand side figure having its flux direction upwards from the paper and downwards into the paper respectively appear when moving a slot window over the magnets.

Although favorable the scope of the invention must not be limited by the embodiments presented but also contains embodiments obvious to a person skilled in the art. For instance the rotor may comprise a spoke wheel having a large radius and comprising a peripheral tubular part on which the permanent magnets are attached. By making the radius large a greater number of lines of teeth and rows of magnets is achieved. Such machine is suitable for low speed applications such as windmills yet producing a high frequency electric power. The metal sheets forming the lines of teeth may consist of standard laminations with slots being punched with standard equipment.

The rotor back may comprise a solid iron body to close the flux paths in the rotor. The concentrated winding in the stator is made up of a set of identical coils that are wound around the teeth. The tubular rotor part may be provided of any suitable material such as metal or reinforced plastic. In order to minimize the weight the rotor may be produced in a thin tube of titan or carbon reinforced plastic.

1. A transverse flux rotating machines comprising:
a first interacting part comprising an electric winding and
a second interacting part comprising a plurality of magnetic poles, the first and second interacting parts being movable relative to each other and defining between them an airgap, wherein the machine when energized by the winding comprises a plurality of magnetic flux loops oriented in a plane perpendicular to the direction of the movement, wherein a bundle of magnetic flux loops forms a leg portion crossing the airgap, wherein the leg portion comprises a first leg part located in the first interacting part and a second leg part located in the second interacting part, wherein the first leg part comprises an elongated magnetic flux conductor, wherein the second leg part comprises one magnetic pole of the plurality of magnetic poles, and wherein the winding comprises an electric coil wound around the magnetic flux conductor.

2. The transverse flux rotating machine according to claim 1, wherein the plurality of magnetic poles are arranged in a plurality of circular rows each row oriented in a plane perpendicular to the axis.

3. The transverse flux rotating machine according to claim 2, wherein a first pole in a first row is displaced in the direction of the movement in comparison with a second pole in a second row.

4. The transverse flux rotating machine according to claim 1, wherein the poles comprise permanent magnets.

5. The transverse flux rotating machine according to claim 4, wherein the second interacting part comprises a first magnet in a first row, a second magnet in a second row and at least one intermediate magnet between the first and second magnets to form a Halbach arrangement.

6. The transverse flux linear machine according to claim 1, wherein the second interacting part comprises a rotor back for magnetically connecting the permanent magnets in lines perpendicular to the movement.

7. The transverse flux rotating machine according to claim 1, wherein the first interacting part comprises a plurality of elongated magnetic flux conductors arranged in lines in a plane in parallel with the axis.

8. The transverse flux rotating machine according to claim 7, wherein the plurality of elongated magnetic flux conductors are integrated with each other by a stator back.

9. The transverse flux rotating machine according to claim 7, wherein the elongated magnetic flux conductors and the back are made of a magnetizable sheet material.

10. The transverse flux rotating machine according to claim 1, wherein the second interacting part comprises a tubular cross section.

11. The transverse flux rotating machine according to claim 7, wherein the electric coil is wound around a plurality of teeth in the direction of the movement.

12. A method for forming a magnetic flux in a transverse magnetic flux rotating machine comprising a first interacting part comprising an electric winding and a second interacting part comprising a plurality of magnetic poles, the first and second interacting parts being movable relative to each other and defining between them an airgap, the method comprising:
providing by energizing the winding a plurality of flux loops oriented in a plane perpendicular to the direction of the movement,
forming from a bundle of the flux loops a leg portion crossing the airgap, the leg portion comprising a first leg part located in the first interacting part and a second leg part located in the second interacting part,
providing the first leg part to contain an elongated magnetic flux conductor,
providing the second leg part to contain a magnetic pole, and
winding a part of the electric winding around the flux conductor to form an electric coil for generating within the leg portion a magnetic flux interacting with the magnetic flux of the pole.

13. The method according to claim 12, wherein the magnetic poles are provided in circular rows each oriented in a plane perpendicular to the axis.

14. The method according to claim 12, wherein the plurality of elongated magnetic flux conductors are integrated with each other by a back and arranged in lines oriented in a plane in parallel with axis.

15. Use of a transverse flux machine according to claim 1 for generating electric power from a windmill.

16. Use of a method according to claim 12 for generating electric power from a windmill.
